(19) United States
(12) Patent Application Publication
(10) Pub. No.: US 2026/0174079 A1
(43) Pub. Date: Jun. 25, 2026

(54) ANTIMICROBIAL NYLON MATERIALS, THEIR PREPARATION METHODS AND APPLICATIONS

(71) Applicant: Changchun Institute of Applied Chemistry Chinese Academy of Sciences, Changchun City (CN)

(72) Inventors: Youhua TAO, Changchun City (CN); Siqi WANG, Changchun City (CN); Jinlong CHEN, Changchun City (CN)

(73) Assignee: Changchun Institute of Applied Chemistry Chinese Academy of Sciences, Changchun City (CN)

(21) Appl. No.: 19/422,578

(22) Filed: Dec. 17, 2025

(30) Foreign Application Priority Data
Dec. 20, 2024 (CN) 202411888646.8

(51) Int. Cl. A01N 37/26; A01P 1/00

(52) U.S. Cl. CPC A01N 37/26; A01P 1/00

(57) ABSTRACT

The present application discloses an antimicrobial nylon material, along with its preparation method and application. The present application relates to the technical field of antimicrobial polymer materials and addresses the limitations of existing antimicrobial nylon 6, particularly its insufficient antimicrobial efficacy and challenges in scalability for industrial production. In the present application, a seven-membered cyclic lysine-derived monomer is copolymerized with a lactam via hydrolytic copolymerization using water as an initiator, yielding a copolyamide. The resulting copolyamide is then subjected to a protonation reaction through heating and stirring in an acidic solution, followed by purification to obtain the final antimicrobial nylon material. The seven-membered cyclic lysine-derived monomer may be an unprotected cyclic lysine monomer, a mono-protected cyclic lysine monomer, or a salt form cyclic lysine monomer. The present invention exhibits broad applicability in antimicrobial-sensitive fields such as textiles, plates, pipes, packages or panels.

### TECHNICAL FIELD OF INVENTION

The present application relates to the technical field of antimicrobial polymer materials, and particularly to antimicrobial nylon materials, and their preparation methods and applications.

### BACKGROUND OF INVENTION

Various harmful microbes such as bacteria, fungi, and viruses widely exist in nature. Daily life activities may be contaminated by these harmful microbes, which may cause malignant infection in some cases, threatening health or even life. Antimicrobial polymer materials could inhibit and kill microbes such as bacteria and fungi attached to their surfaces and have been widely used in fields of health, medical care, environment protection and the like. In recent years, with continued focus on health, there is an increasing need for antimicrobial polymer materials.

Nylon is a polymer material containing repeated amide groups in its molecular chain, which has excellent performances, has been widely applied in the fields such as personal care, textiles, automobiles, engineering plastics and packages, and is almost ubiquitous in our daily lives. However, conventional nylon materials are prone to promote the growth of harmful microbes such as bacteria, fungi, and viruses under environmental conditions for daily storage and use, which endangers living environment and people's health. Currently, commercial antimicrobial nylon materials are mainly produced by blending polyamides with small molecule antimicrobial agents (such as silver particles and copper particles). However, such antimicrobial nylon materials still have many problems in terms of the safety, the environmental friendliness as well as the effectiveness and persistence of the antimicrobial properties. Therefore, it is still of great significance to develop an environmentally friendly, safe, persistent and highly effective antimicrobial nylon material.

Lysine (also known as 2,6-diaminohexanoic acid) is a natural renewable chemical, which is abundant and inexpensive. A seven-membered cyclic lysine-derived monomer can be obtained by cyclization of lysine, which has the same cyclic structure as ε-caprolactam, and can be copolymerized with other lactams via ring-opening polymerization, such that functional groups are introduced on the side chain of nylons. Subsequent post-modification imparts antimicrobial properties to the material, offering a novel strategy for the development of antimicrobial nylon materials. In this regard, the literature ACS Macro Lett. 2022, 11, 46-52 reported that a seven-membered cyclic lysine-derived monomer was copolymerized with ε-caprolactam via ring-opening polymerization to introduce dimethylamino group on the side chain of nylon-6. After quaternization of the resultant copolymer with bromoethane, an antimicrobial nylon 6 material was obtained. However, the mechanical properties of the prepared antibacterial nylon 6 were not satisfactory. CN115707727A also reported a method for preparing an antimicrobial nylon-6 material by copolymerizing a seven-membered cyclic lysine-derived monomer with ε-caprolactam via ring-opening polymerization and then quaternizing the resultant copolyamide with a haloalkane. In this method, attempts were also made to use hydrochloric acid instead of haloalkane to modify the copolyamide, but its antimicrobial properties were poor. However, these methods require the use of seven-membered cyclic lysine-derived monomers with dual-protected amino groups as materials, and the dissolution of the resulting copolyamide in trifluoroethanol for the subsequent haloalkane quaternization. This leads to a complicated preparation process, low production efficiency, and high production cost, which are not advantageous for industrial production of antimicrobial nylon 6 materials.

### SUMMARY OF INVENTION

To overcome the problems such as poor antimicrobial properties and difficulty in industrial production of existing antimicrobial nylon 6, the present application provides an antimicrobial nylon material, preparation method and use thereof.

Specifically, technical solutions for the present invention are as follows.

An antimicrobial nylon material comprises two different kinds of repeating units respectively represented by Formula I and Formula II in its molecular structure:

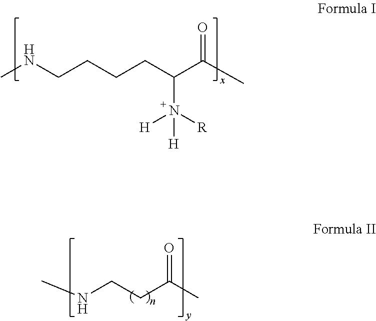

wherein R is one selected from the group consisting of hydrogen; substituted or unsubstituted, linear or branched, saturated or unsaturated aliphatic C₁₋₂₈ hydrocarbyl; substituted or unsubstituted, saturated or unsaturated alicyclic C₃₋₁₅ hydrocarbyl; substituted or unsubstituted C₆₋₂₂ aryl; and substituted or unsubstituted, saturated or unsaturated C₇₋₃₅ aralkyl; wherein the expression “substituted” means that the respective group is substituted by one or more substituents selected from halogen, nitro, and linear or branched C₁₋₁₈ alkyl;
n is any natural number selected from 1 to 8; and
x and y represent the molar ratio of respective repeating units, wherein x is selected from 0.01 to 0.50, y is selected from 0.50 to 0.99, and x+y=1.

Preferably, R is one selected from the group consisting of hydrogen, methyl, ethyl, propyl, isopropyl, butyl, t-butyl, hexyl, cyclohexyl, dodecyl, phenyl, and benzyl.

The present application also provides a method for preparing the antimicrobial nylon material as described above, comprising the steps of:
Step 1: mixing a seven-membered cyclic lysine-derived monomer with a lactam to cause hydrolysis polymerization with water as an initiator to obtain a copolyamide; and
Step 2: placing the resultant copolyamide into an acid solution, heating and stirring the solution to occur a protonation reaction, and then purifying the resultant reaction product to obtain the antimicrobial nylon material;
wherein the seven-membered cyclic lysine-derived monomer has a structure represented by Formula III, or is a salt form cyclic lysine monomer obtained by reacting the pendant amino (or the mono-protected amino —NHR) on the ring of the structure represented by Formula III with an acid:

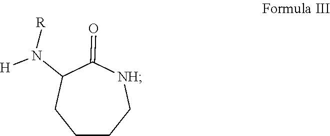

Specifically, when R is hydrogen, the seven-membered cyclic lysine-derived monomer is abbreviated as an unprotected cyclic lysine monomer; and when R is any other substituent, the seven-membered cyclic lysine-derived monomer is abbreviated as a mono-protected cyclic lysine monomer.

The lactam has a structure represented by the following Formula IV:

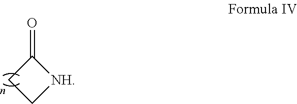

The acid used in the acid solution is one selected from the group consisting of hydrides or oxyacids of halogen; hydrides or oxyacids of sulfur, nitrogen or phosphorous; C₁₋₃₅ mono- to penta-carboxylic acids, hydroxy carboxylic acids and sulfonic acids.

Preferably, the seven-membered cyclic lysine-derived monomer is prepared through a method comprising steps of:
mixing lysine or lysine hydrochloride with methanol, adding or not adding an equimolar equivalent of sodium hydroxide, carrying out dehydration-cyclization reaction at 125° C.-200° C., and then extracting the resultant reaction mixture with ethyl acetate to obtain an α-amino-ε-caprolactam (an unprotected cyclic lysine monomer of Formula III where R is H); or
reacting an α-amino-ε-caprolactam with a corresponding acid, aldehyde or halohydrocarbon having an R group to obtain a mono-protected cyclic lysine monomer; or
reacting an unprotected or mono-protected cyclic lysine monomer with an acid to obtain a salt form cyclic lysine monomer.

Preferably, in Step 1, the molar ratio of the seven-membered cyclic lysine-derived monomer to the lactam is in a range from 0.01:1 to 1:1, and more preferably in a range from 0.01:1 to 0.8:1; and
the ratio of the total mass of the seven-membered cyclic lysine-derived monomer and the lactam to the mass of water is in a range from 10:1 to 200:1, and more preferably in a range from 20:1 to 100:1.

Preferably, a catalyst is added in Step 1, wherein the catalyst is one or a mixture of at least two selected from the group consisting of hydrides or oxyacids of halogen; oxyacids of sulfur, nitrogen or phosphorous; C₁₋₃₅ mono- to penta-carboxylic acids, hydroxy acids, amino acids, sulfonic acids or phosphoric acid; hydroxides, carbonates, bicarbonates, or basic carbonates of alkaline metal or alkaline earth metal; and
the molar ratio of the catalyst to a sum of the seven-membered cyclic lysine-derived monomer and the lactam is in a range from 0.001:1 to 0.1:1.

Preferably, the hydrolysis polymerization in Step 1 is occurred under the following conditions: a polymerization temperature of 140° C.-320° C., a polymerization time of 2 h-96 h, and a polymerization pressure of −0.1 MPa-5 MPa.

Preferably, the hydrolysis polymerization may be divided to three stages of increased pressure reaction, normal pressure reaction and reduced pressure reaction, which are occurred under the following reaction conditions:
Stage of increased pressure reaction: a polymerization temperature of 140° C.-230° C., a polymerization time of 2 h-24 h, and a polymerization pressure of 0.3 MPa-5 MPa;
Stage of normal pressure reaction: a polymerization temperature of 180° C.-280° C., a polymerization time of 0.5 h-10 h, and a polymerization pressure of −0.05 MPa-0.1 MPa; and
Stage of reduced pressure reaction: a polymerization temperature of 200° C.-320° C., a polymerization time of 2 h-36 h, and a polymerization pressure of −0.1 MPa-0 MPa.

Preferably, a solute or acid used in the acid solution in Step 2 is one or a combination of at least two selected from the group consisting of hydrides or oxyacids of halogen; hydrides or oxyacids of sulfur, nitrogen or phosphorous; C₁₋₃₅ mono- to penta-carboxylic acids, hydroxy carboxylic acids, or sulfonic acids; more preferably one or a combination of at least two selected from the group consisting of hydrochloric acid, hydrobromic acid, sulfuric acid, nitric acid, phosphoric acid, formic acid, acetic acid, propionic acid, butyric acid, hexanoic acid, octanoic acid, hexadecanoic acid, benzoic acid, lactic acid, mandelic acid, salicylic acid, tartaric acid, malic acid, citric acid, methanesulfonic acid, and p-toluenesulfonic acid; and further preferably one or a combination of at least two selected from the group consisting of hydrochloric acid, phosphoric acid, acetic acid, benzoic acid, tartaric acid, citric acid, and p-toluenesulfonic acid.

A solvent used in the acid solution is one or a combination of at least two selected from the group consisting of diethyl ether, methyl t-butyl ether, tetrahydrofuran, ethylene carbonate, propylene carbonate, acetonitrile, methyl ethyl ketone, acetone, methanol, ethanol, butanol, dichloromethane, carbon disulfide, chloroform, ethyl acetate, ethyl isovalerate, N,N-dimethylformamide, N,N-dimethylacetamide, and dimethyl sulfoxide.

Preferably, in Step 2, for protonating each gram of copolyamide, 0.1 mL-20 mL of a solvent and 0.01 g-10 g of an acid are required for the acid solution; the temperature for heating is 20° C.-180° C.; and the time for stirring is 10 min-48 h.

Preferably, the purifying process in Step 2 comprises washing with a washing solvent, wherein the washing solvent is one or a combination of at least two selected from the group consisting of water, methanol, ethanol, dichloromethane, acetone and ethyl acetate; the time for washing is 0.1 h-24 h, and the temperature for washing is 25° C.-100° C.

The present invention also provides an article comprising the antimicrobial nylon material according to the present application, or an antimicrobial nylon material obtained by the method according to the present application.

Preferably, the article is selected from textiles, plates, pipes, packages or panels.

Comparing with the prior art, the specific beneficial effects provided by the present application are as follows:
1. The present application addresses the limitations of existing preparation technologies for antimicrobial nylon material. It provides an antimicrobial nylon material by the ring-opening copolymerization of an unprotected, a mono-protected or a salt form seven-membered cyclic lysine-derived monomer with lactam, followed by protonation of the resulting copolyamide with an acid solution. The antimicrobial nylon material exhibits highly effective antimicrobial effects and can be processed and molded using standard techniques such as injection molding, blow molding, extrusion molding, or spinning. Furthermore, the antimicrobial nylon material retains comparable mechanical properties to conventional nylon materials and can be widely applied in the fields requiring antimicrobial properties such as textiles, plates, pipes, packages, and panels.
2. Comparing to prior art, the preparation method provided by the present application does not require the addition of additional antimicrobial agents, avoiding complicated operations such as melt blending. Meanwhile, the method also avoids the use of trifluoroethanol for dissolving the copolyamide in post-modification steps, which can effectively reduce the use of reagents such as haloalkanes and solvents such as trifluoroethanol. The method of the present application has advantages such as simple preparation process, high production efficiency, and low production cost, and is suitable for the industrial production of antimicrobial nylon materials.

### BRIEF DESCRIPTION OF DRAWINGS

FIG. 1 is a ¹H-NMR spectrum of the antimicrobial nylon material according to Example 1.

FIG. 2 is a ¹H-NMR spectrum of the antimicrobial nylon material according to Example 2.

FIG. 3 is a ¹H-NMR spectrum of the antimicrobial nylon material according to Example 3.

FIG. 4 is a ¹H-NMR spectrum of the antimicrobial nylon material according to Example 4.

FIG. 5 is a picture showing the antimicrobial effect of the antimicrobial nylon material according to Example 1 against Staphylococcus aureus;

FIG. 6 is a picture showing the antimicrobial effect of the antimicrobial nylon material according to Comparative Example 1 against Staphylococcus aureus.

### DETAILED DESCRIPTION OF INVENTION

To make the technical solutions of the present application clearer, the technical solutions in examples of the present application will be described in detail and fully below with reference to the drawings. It should be noted that the following examples are merely for the purpose of better understanding the technical solutions of the present application and should not be construed in any way as limiting the present application.

Any specific numerical value (including endpoints of a numerical range) disclosed herein should not be limited to the exact value of that numerical value but should be understood to also cover values close to that exact value, for example all possible values within ±5% of that exact value. Also, for the numerical ranges disclosed herein, one or more new numerical ranges can be obtained by arbitrarily combing values between the endpoint values of that range, between any endpoint value and any specific value within that range, and between individual specific values, and these new numerical ranges should be also regarded as being specifically disclosed herein.

The terms used herein have the same meanings as commonly understood by those skilled in the art, unless otherwise stated. If a term is defined herein, and its definition is different from that commonly understood in the art, the definition herein shall control.

Herein, unless specifically stated, any matter or item not mentioned shall directly apply to those known in the art without any change. Also, any embodiment described herein can be freely combined with one or more other embodiments described herein, and the technical solutions or technical ideas thus formed shall be regarded as a part of the original disclosure or description of the present disclosure, and shall not be regarded as new contents that are not disclosed or contemplated herein, unless those skilled in the art consider such a combination obviously unreasonable.

### Example 1

(1) Preparation of α-amino-ε-caprolactam (an unprotected cyclic lysine of Formula III where in R═H):

640 g (3.5 mol) lysine hydrochloride, 140 g (3.5 mol) sodium hydroxide and 3.5 L methanol were added into a 5 L autoclave and reacted under stirring at 150° C. for 6 h. The resultant mixture was cooled to room temperature, suction filtered to remove insoluble substances, then evaporated to dryness with methanol being recovered, and the resultant solid was extracted with ethyl acetate to obtain the α-amino-ε-caprolactam with a yield of 94%, and a purity of 99% as analyzed by ¹H-NMR spectroscopy. ¹H-NMR spectroscopy test results: ¹H NMR (300 MHz, D₂O): δ 3.69-3.72 (dd, 1H), 3.22-3.26 (m, 2H), 1.26-1.99 (m, 6H).

### (2) Preparation of Copolyamide:

50 g (400 mmol) of the α-amino-ε-caprolactam prepared in above step (1) and 450 g (3960 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 80%, and a number-average molecular weight of 27.8 kDa as measured by GPC. ¹H-NMR spectroscopy test results: ¹H NMR (500 MHz, TFA/CDCl₃, 1:5, v:v): δ 3.27-3.09 (m, 4H), 3.06-2.99 (m, 1H), 2.35-2.14 (m, 2H), 1.74-1.15 (m, 12H).

### (3) Preparation of Antimicrobial Nylon:

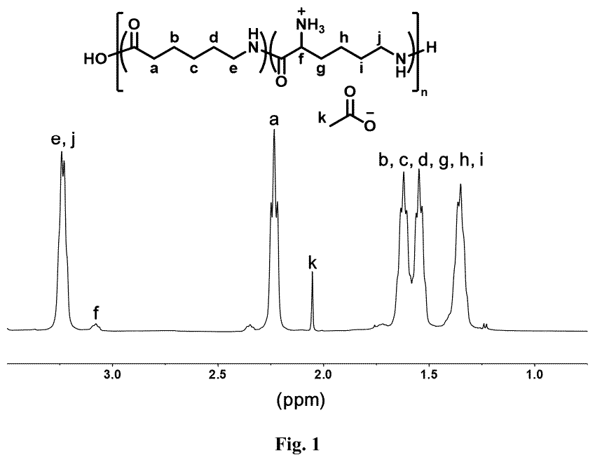

500 mL ethanol and 30 g acetic acid were added into 100 g of the copolyamide granules prepared in above step (2). The resultant mixture was heated under reflux at 70° C. for 5 h and then filtered. The granules were put into 1000 mL water and washed with water at 70° C. for 5 h to obtain antimicrobial nylon granules with a yield of 98%. ¹H NMR spectrum in FIG. 1 showed that the molar percentage of the protonated seven-membered cyclic lysine derivative in the antimicrobial nylon material was 9.5%.

### Example 2

### (1) Preparation of Copolyamide:

25 g (200 mmol) of the α-amino-ε-caprolactam prepared in step (1) of Example 1 and 475 g (4180 mmol) ε-caprolactam were heated and melted in an autoclave, and then 15 mL (830 mmol) water was added. The resultant mixture was subjected to an increased pressure reaction at 180° C. and 0.8 MPa for 5 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 83%, and a number-average molecular weight of 20.1 kDa as measured by GPC. ¹H-NMR spectroscopy test results: ¹H NMR (500 MHz, TFA/CDCl₃, 1:5, v:v): δ 3.28-3.09 (m, 4H), 3.07-3.04 (m, 1H), 2.36-2.12 (m, 2H), 1.74-1.16 (m, 12H).

### (2) Preparation of Antimicrobial Nylon:

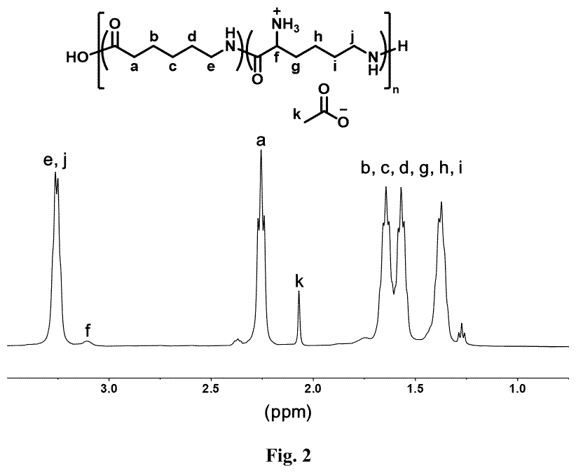

500 mL ethanol and 30 g acetic acid were added into 100 g of the copolyamide granules prepared in above step (1). The resultant mixture was heated under reflux at 70° C. for 5 h and then filtered. The granules were put into 1000 mL water and washed with water at 70° C. for 5 h to obtain antimicrobial nylon granules with a yield of 99%. ¹H NMR spectrum in FIG. 2 showed that the molar percentage of the protonated seven-membered cyclic lysine derivative in the antimicrobial nylon material was 4%.

### Example 3

### (1) Preparation of Copolyamide:

75 g (590 mmol) of the α-amino-ε-caprolactam prepared in step (1) of Example 1 and 425 g (3740 mmol) ε-caprolactam were heated and melted in an autoclave, and then 15 mL (830 mmol) water was added. The resultant mixture was subjected to an increased pressure reaction at 200° C. and 1.0 MPa for 6 h, followed by a normal pressure reaction at 210° C. and 0 MPa for 1 h, and then a reduced pressure reaction at 210° C. and −0.1 MPa for 2 h. The resultant mixture was discharged and granulated to obtain the copolyamide product with a yield of 85%, and a number-average molecular weight of 35.6 kDa as measured by GPC. ¹H-NMR spectroscopy test results: ¹H NMR (500 MHz, TFA/CDCl₃, 1:5, v:v): δ 3.30-3.08 (m, 4H), 3.05-2.99 (m, 1H), 2.36-2.10 (m, 2H), 1.78-1.16 (m, 12H).

### (2) Preparation of Antimicrobial Nylon:

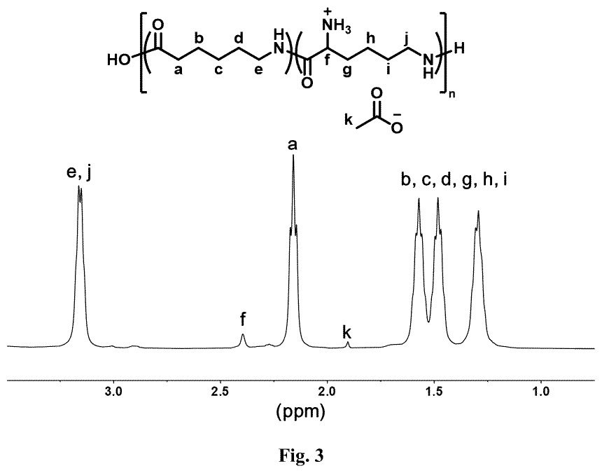

500 mL ethanol and 30 g acetic acid were added into 100 g of the copolyamide granules prepared in above step (1). The resultant mixture was heated under reflux at 70° C. for 5 h and then filtered. The granules were put into 1000 mL water and washed with water at 70° C. for 5 h to obtain antimicrobial nylon granules with a yield of 96%. ¹H NMR spectrum in FIG. 3 showed that the molar percentage of the protonated seven-membered cyclic lysine derivative in the antimicrobial nylon material was 14%.

### Example 4

### (1) Preparation of Copolyamide:

100 g (780 mmol) of the α-amino-ε-caprolactam prepared in step (1) of Example 1 and 400 g (3520 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 220° C. and 0 MPa for 1 h, and then a reduced pressure reaction at 220° C. and −0.1 MPa for 1.5 h. The resultant mixture was discharged and granulated to obtain the copolyamide product with a yield of 88%, and a number-average molecular weight of 41.7 kDa as measured by GPC. ¹H-NMR spectroscopy test results: ¹H NMR (500 MHz, TFA/CDCl₃, 1:5, v:v): δ 3.28-2.99 (m, 5H), 2.36-2.18 (m, 2H), 1.77-1.10 (m, 12H).

### (2) Preparation of Antimicrobial Nylon:

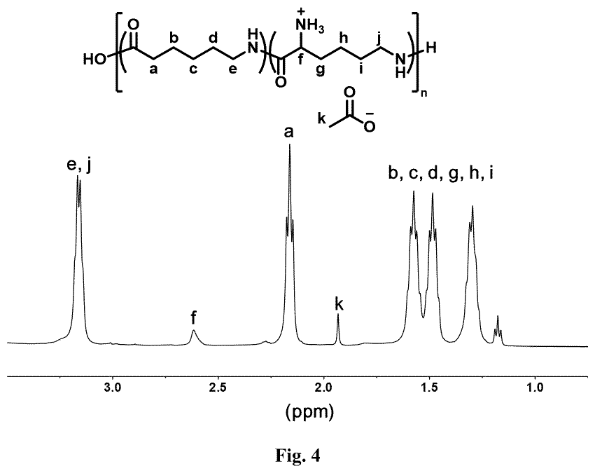

500 mL ethanol and 50 g acetic acid were added into 100 g of the copolyamide granules prepared in above step (1). The resultant mixture was heated under reflux at 70° C. for 5 h and then filtered. The granules were put into 1000 mL water and washed with water at 70° C. for 5 h to obtain antimicrobial nylon granules with a yield of 99%. ¹H NMR spectrum in FIG. 4 showed that the molar percentage of the protonated seven-membered cyclic lysine derivative in the antimicrobial nylon material was 18.7%.

### Example 5

### (1) Preparation of Copolyamide:

125 g (1000 mmol) of the α-amino-ε-caprolactam prepared in step (1) of Example 1 and 375 g (3320 mmol) ε-caprolactam were heated and melted in an autoclave, and then 15 mL (830 mmol) water was added. The resultant mixture was subjected to an increased pressure reaction at 210° C. and 1.2 MPa for 8 h, followed by a normal pressure reaction at 230° C. and 0 MPa for 1 h, and then a reduced pressure reaction at 230° C. and −0.1 MPa for 3 h. The resultant mixture was discharged and granulated to obtain the copolyamide product with a yield of 86%, and a number-average molecular weight of 53.9 kDa as measured by GPC. ¹H-NMR spectroscopy test results: ¹H NMR (500 MHz, TFA/CDCl₃, 1:5, v:v): δ 3.29-3.04 (m, 4H), 3.03-2.98 (m, 1H), 2.34-2.10 (m, 2H), 1.70-1.09 (m, 12H).

### (2) Preparation of Antimicrobial Nylon:

500 mL ethanol and 80 g acetic acid were added into 100 g of the copolyamide granules prepared in above step (1). The mixture was heated under reflux at 70° C. for 5 h and then filtered. The granules were put into 1000 mL water and washed with water at 70° C. for 5 h to obtain antimicrobial nylon granules with a yield of 95%. ¹H NMR spectrum showed that the molar percentage of the protonated seven-membered cyclic lysine derivative in the antimicrobial nylon material was 24.3%.

### Example 6

### (1) Preparation of Copolyamide:

25 g (200 mmol) of the α-amino-ε-caprolactam prepared in step (1) of Example 1 and 475 g (4180 mmol) ε-caprolactam were heated and melted in an autoclave, and then 30 mL (1660 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 85%, and a number-average molecular weight of 15.1 kDa as measured by GPC. ¹H-NMR spectroscopy test results: ¹H NMR (500 MHz, TFA/CDCl₃, 1:5, v:v): δ 3.31-3.10 (m, 4H), 3.08-3.06 (m, 1H), 2.35-2.13 (m, 2H), 1.73-1.18 (m, 12H).

### (2) Preparation of Antimicrobial Nylon:

500 mL ethanol and 30 g acetic acid were added into 100 g of the copolyamide granules prepared in above step (1). The resultant mixture was heated under reflux at 70° C. for 5 h and then filtered. The granules were put into 1000 mL water and washed with water at 70° C. for 5 h to obtain antimicrobial nylon granules with a yield of 98%. ¹H NMR spectrum showed that the molar percentage of the protonated seven-membered cyclic lysine derivative in the antimicrobial nylon material was 4.3%.

### Example 7

500 mL methanol and 50 g benzoic acid were added into 100 g of the copolyamide granules prepared in step (2) of Example 2. The resultant mixture was heated under reflux at 60° C. for 5 h and then filtered. The granules were put into 1000 mL water and washed with ethanol at 70° C. for 5 h to obtain antimicrobial nylon granules with a yield of 94%. ¹H NMR spectrum showed that the molar percentage of the protonated seven-membered cyclic lysine derivative in the antimicrobial nylon material was 4.5%.

### Example 8

500 mL tetrahydrofuran and 70 g citric acid were added into 100 g of the copolyamide granules prepared in above step (2) of Example 2. The resultant mixture was heated under reflux at 70° C. for 5 h and then filtered. The granules were put into 1000 mL water and washed with water at 70° C. for 5 h to obtain antimicrobial nylon granules with a yield of 96%. ¹H NMR spectrum showed that the molar percentage of the protonated seven-membered cyclic lysine derivative in the antimicrobial nylon material was 3.8%.

### Example 9

(1) Preparation of Monomethyl α-amino-ε-caprolactam (a Mono-Protected Cyclic Lysine of Formula III where R═CH₃):

1 L n-hexane and 55 mL (860 mmol) methyl formate were added into 100 g (780 mmol) of the α-amino-ε-caprolactam prepared in step (1) of Example 1. The mixture was heated under reflux with a water separator for 5 h and then filtered. The filtered solid was dissolved in 500 mL methanol, and then 44 g (1170 mmol) sodium borohydride was added. The resultant mixture was reacted for 3 h and then recrystallized to obtain the product with a yield of 75%. The purity as analyzed by ¹H-NMR spectroscopy was 98%. ¹H-NMR spectroscopy test results: ¹H NNR (300 MHz, D₂O): δ 3.68-3.73 (dd, 1H), 3.38 (s, 3H), 3.21-3.27 (m, 5H), 1.30-2.01 (m, 6H).

### (2) Preparation of Copolyamide:

50 g (350 mmol) of the monomethyl α-amino-ε-caprolactam prepared in above step (1) and 450 g (3960 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 80%, and a number-average molecular weight of 18.6 kDa as measured by GPC. ¹H-NMR spectroscopy test results: ¹H NMR (500 MHz, TFA/CDCl₃, 1:5, v:v): δ 3.36 (s, 3H), 3.25-3.08 (m, 4H), 3.06-2.98 (m, 1H), 2.32-2.18 (m, 2H), 1.79-1.13 (m, 12H).

### (3) Preparation of Antimicrobial Nylon:

500 mL acetonitrile and 30 g acetic acid were added into 100 g of the copolyamide granules prepared in above step (2). The resultant mixture was heated under reflux at 70° C. for 5 h and then filtered. The granules were put into 1000 mL water and washed with water at 70° C. for 5 h to obtain antimicrobial nylon granules with a yield of 96%. ¹H NMR spectrum showed that the molar percentage of the protonated seven-membered cyclic lysine derivative in the antimicrobial nylon material was 8.7%.

### Example 10

(1) Preparation of Monoethyl α-amino-ε-caprolactam (a Mono-Protected Cyclic Lysine of Formula III where R═CH₂CH₃):

1 L methanol, a 105 mL solution of acetaldehyde (940 mmol) in ethanol and 105 g (1000 mmol) anhydrous sodium carbonate were added into 100 g (780 mmol) of the α-amino-ε-caprolactam prepared in step (1) of Example 1. The resultant mixture was heated under reflux for 5 h and then filtered. 44 g (1170 mmol) sodium borohydride was added into the filtrate. The resultant mixture was reacted for 3 h and then recrystallized to obtain the product with a yield of 63%. The purity as analyzed by ¹H-NMR spectroscopy was 95%. ¹H-NMR spectroscopy test results: ¹H NMR (300 MHz, D₂O): δ 3.69-3.72 (dd, 1H), 3.22-3.26 (m, 2H), 2.59 (m, 2H), 1.26-1.99 (m, 6H), 1.13 (t, 3H).

### (2) Preparation of Copolyamide:

50 g (320 mmol) of the monoethyl α-amino-ε-caprolactam prepared in above step (1) and 450 g (3960 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 79%, and a number average molecular weight of 19.5 kDa as measured by GPC. H-NMR spectroscopy test results: ¹H NMR (500 MHz, TFA/CDCl₃, 1:5, v:v): δ 3.28-2.95 (m, 5H), 2.61 (m, 2H), 2.30-2.09 (m, 2H), 1.80-1.12 (m, 15H).

### (3) Preparation of Antimicrobial Nylon:

500 mL tetrahydrofuran and 30 g acetic acid were added into 100 g of the copolyamide granules prepared in above step (2). The resultant mixture was heated under reflux at 70° C. for 5 h and then filtered. The granules were put into 1000 mL water and washed with water at 70° C. for 5 h to obtain antimicrobial nylon granules with a yield of 98%. ¹H NMR spectrum showed that the molar percentage of the protonated seven-membered cyclic lysine derivative in the antimicrobial nylon material was 8.5%.

### Example 11

(1) Preparation of Monobenzyl α-amino-ε-caprolactam (a Mono-Protected Cyclic Lysine of Formula III Where R═CH₂Ph):

1.5 L methanol, 100 mL (980 mmol) benzaldehyde and 105 g (1000 mmol) anhydrous sodium carbonate were added into 100 g (780 mmol) of the α-amino-ε-caprolactam prepared in step (1) of Example 1. The resultant mixture was heated under reflux for 4 h and then filtered. 44 g (1170 mmol) sodium borohydride was added into the filtrate. The resultant mixture was reacted for 3 h and then recrystallized to obtain the product with a yield of 70%. The purity as analyzed by ¹H-NMR spectroscopy was 97%. ¹H-NMR spectroscopy test results: ¹H NMR (300 MHz, D₂O): δ 7.50-7.31 (m, 5H), 4.62 (s, 2H), 3.65-3.70 (dd, 1H), 3.21-3.27 (m, 2H), 1.20-1.97 (m, 6H).

### (2) Preparation of Copolyamide:

70 g (320 mmol) of the monobenzyl α-amino-ε-caprolactam prepared in above step (1) and 450 g (3960 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 82%, and a number-average molecular weight of 20.1 kDa as measured by GPC. ¹H-NMR spectroscopy test results: ¹H NNR (500 MHz, TFA/CDCl₃, 1:5, v:v): δ 7.52-7.34 (m, 5H), 3.81 (s, 2H), 3.24-3.09 (m, 4H), 3.05-2.97 (m, 1H), 2.40-2.18 (m, 2H), 1.79-1.12 (m, 12H).

### (3) Preparation of Antimicrobial Nylon:

500 mL acetonitrile and 30 g acetic acid were added into 100 g of the copolyamide granules prepared in above step (2). The resultant mixture was heated under reflux at 70° C. for 5 h and then filtered. The granules were put into 1000 mL water and washed with water at 70° C. for 5 h to obtain antimicrobial nylon granules with a yield of 98%. ¹H NMR spectrum showed that the molar percentage of the protonated seven-membered cyclic lysine derivative in the antimicrobial nylon material was 7.5%.

### Example 12

(1) Preparation of Monododecyl α-amino-ε-caprolactam (a Mono-Protected Cyclic Lysine of Formula III where R═(CH₂)₁₁CH₃):

1 L water, 80 g (940 mmol) sodium bicarbonate, 3 g sodium dodecyl sulfonate, and 225 mL (940 mmol) bromododecane were added into 100 g (780 mmol) of the α-amino-ε-caprolactam prepared in step (1) of Example 1. The resultant mixture was heated under reflux at 80° C. for 5 h and then filtered. The filtrate was washed three times with 2 L dichloromethane. The organic phase was dried by rotary evaporation and then recrystallized to obtain the product with a yield of 45%. The purity as analyzed by ¹H-NMR spectroscopy was 92%. ¹H-NMR spectroscopy test results: ¹H NMR (300 MHz, D₂O): δ 3.69-3.72 (dd, 1H), 3.22-3.26 (m, 2H), 2.53 (t, 2H), 1.26-1.99 (m, 26H), 0.88 (t, 3H).

### (2) Preparation of Copolyamide:

100 g (340 mmol) of the monododecyl α-amino-ε-caprolactam prepared in above step (1) and 450 g (3960 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 81%, and a number average molecular weight of 30.5 kDa as measured by GPC. ¹H-NMR spectroscopy test results: ¹H NMR (500 MHz, TFA/CDCl₃, 1:5, v:v): δ 3.28-3.07 (m, 4H), 3.03-2.90 (m, 1H), 2.55-2.19 (m, 4H), 1.74-0.87 (m, 35H).

### (3) Preparation of Antimicrobial Nylon:

500 mL chloroform and 30 g acetic acid were added into 100 g of the copolyamide granules prepared in above step (2). The resultant mixture was heated under reflux at 70° C. for 5 h and then filtered. The granules were put into 1000 mL ethanol and washed at 70° C. for 5 h to obtain antimicrobial nylon granules with a yield of 96%. ¹H NMR spectrum showed that the molar percentage of the protonated seven-membered cyclic lysine derivative in the antimicrobial nylon material was 6.3%.

### Example 13

(1) Preparation of α-amino-ε-caprolactam Hydrochloride (a Salt Form Cyclic Lysine of Formula III where R═H):

500 mL acetone and 80 mL (960 mmol) concentrated hydrochloric acid were added into 100 g (780 mmol) of the α-amino-ε-caprolactam prepared in step (1) of Example 1. The resultant mixture was reacted under stirring for 2 h and then filtered to obtain the product with a yield of 90%. The purity as analyzed by ¹H-NMR spectroscopy was 99%. H-NMR spectroscopy test results: ¹H NMR (300 MHz, D₂O): δ 3.75-3.80 (dd, 1H), 3.23-3.28 (m, 2H), 1.27-2.01 (m, 6H).

### (2) Preparation of Copolyamide:

50 g (300 mmol) of the α-amino-ε-caprolactam hydrochloride prepared in above step (1) and 450 g (3960 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 80%, and a number average molecular weight of 25.7 kDa as measured by GPC. ¹H-NMR spectroscopy test results: ¹H NMR (500 MHz, TFA/CDCl₃, 1:5, v:v): δ 3.29-2.97 (m, 5H), 2.36-2.18 (m, 2H), 1.75-1.19 (m, 12H).

### (3) Preparation of Antimicrobial Nylon:

500 mL ethyl acetate and 20 g acetic acid were added into 100 g of the copolyamide granules prepared in above step (2). The resultant mixture was heated under reflux at 70° C. for 5 h and then filtered. The granules were put into 1000 mL water and washed with water at 70° C. for 5 h to obtain antimicrobial nylon granules with a yield of 99%. ¹H NMR spectrum showed that the molar percentage of the protonated seven-membered cyclic lysine derivative in the antimicrobial nylon material was 10.2%.

### Example 14

(1) Preparation of α-amino-ε-caprolactam Benzoate (a Salt Form Cyclic Lysine of Formula III where R═H):

500 mL acetone and 117 g (960 mmol) benzoic acid were added into 100 g (780 mmol) of the α-amino-ε-caprolactam prepared in step (1) of Example 1. The resultant mixture was reacted under stirring for 2 h and then filtered to obtain the product with a yield of 90%. The purity as analyzed by ¹H-NMR spectroscopy was 99%. ¹H-NMR spectroscopy test results: ¹H NMR (300 MHz, D₂O): δ 7.33-7.56 (m, 5H), 3.76-3.83 (dd, 1H), 3.24-3.31 (m, 2H), 1.28-2.00 (m, 6H).

### (2) Preparation of Copolyamide:

75 g (300 mmol) of the α-amino-ε-caprolactam benzoate prepared in above step (1) and 450 g (3960 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 80%, and a number-average molecular weight of 29.8 kDa as measured by GPC. ¹H-NMR spectroscopy test results: ¹H NMR (500 MHz, TFA/CDCl₃, 1:5, v:v): δ 7.37-7.59 (m, 5H), 3.32-2.96 (m, 5H), 2.34-2.17 (m, 2H), 1.78-1.19 (m, 12H).

### (3) Preparation of Antimicrobial Nylon:

500 mL acetone and 20 g acetic acid were added into 100 g of the copolyamide granules prepared in above step (2). The resultant mixture was heated under reflux at 70° C. for 5 h and then filtered. The granules were put into 1000 mL water and washed with water at 70° C. for 5 h to obtain antimicrobial nylon granules with a yield of 98%. ¹H NMR spectrum showed that the molar percentage of the protonated seven-membered cyclic lysine derivative in the antimicrobial nylon material was 11%.

### Example 15

(1) Preparation of Monomethyl α-amino-ε-caprolactam Hydrochloride (a Salt Form Cyclic Lysine of Formula III where R═CH₃):

500 mL acetone and 80 mL (960 mmol) concentrated hydrochloric acid were added into 100 g (700 mmol) of the monomethyl α-amino-ε-caprolactam prepared in step (1) of Example 9. The resultant mixture was reacted under stirring for 2 h and then filtered to obtain the product with a yield of 92%. The purity as analyzed by ¹H-NMR spectroscopy was 99%. ¹H-NMR spectroscopy test results: ¹H NNR (300 MHz, D₂O): δ 3.78-3.84 (dd, 1H), 3.45 (s, 3H), 3.25-3.29 (m, 2H), 1.22-2.04 (m, 6H).

### (2) Preparation of Copolyamide:

50 g (280 mmol) of the monomethyl α-amino-ε-caprolactam hydrochloride prepared in above step (1) and 450 g (3960 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 80%, and a number average molecular weight of 25.4 kDa as measured by GPC. ¹H-NMR spectroscopy test results: ¹H NNR (500 MHz, TFA/CDCl₃, 1:5, v:v): δ 3.49 (s, 3H), 3.28-3.08 (m, 4H), 3.06-2.95 (m, 1H), 2.36-2.14 (m, 2H), 1.73-1.18 (m, 12H).

### (3) Preparation of Antimicrobial Nylon:

500 mL ethanol and 20 g acetic acid were added into 100 g of the copolyamide granules prepared in above step (2). The resultant mixture was heated under reflux at 70° C. for 5 h and then filtered. The granules were put into 1000 mL water and washed with water at 70° C. for 5 h to obtain antimicrobial nylon granules with a yield of 95%. ¹H NMR spectrum showed that the molar percentage of the protonated seven-membered cyclic lysine derivative in the antimicrobial nylon material was 10.4%.

### Example 16

### (1) Preparation of Copolyamide:

50 g (400 mmol) of the α-amino-ε-caprolactam prepared in step (1) of Example 1 and 450 g (4500 mmol) valerolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 220° C. and 0 MPa for 1 h, and then a reduced pressure reaction at 220° C. and −0.1 MPa for 1.5 h. The resultant mixture was discharged and granulated to obtain the copolyamide product with a yield of 78%, and a number average molecular weight of 25.7 kDa as measured by GPC. ¹H-NMR spectroscopy test results: ¹H NMR (500 MHz, TFA/CDCl₃, 1:5, v:v): δ 3.29-2.99 (m, 5H), 2.35-2.22 (m, 2H), 1.76-1.13 (m, 10H).

### (2) Preparation of Antimicrobial Nylon:

500 mL ethanol and 50 g acetic acid were added into 100 g of the copolyamide granules prepared in above step (1). The resultant mixture was heated under reflux at 70° C. for 5 h and then filtered. The granules were put into 1000 mL water and washed with water at 70° C. for 5 h to obtain antimicrobial nylon granules with a yield of 98%. ¹H NMR spectrum showed that the molar percentage of the protonated seven-membered cyclic lysine derivative in the antimicrobial nylon material was 19.5%.

### Example 17

### (1) Preparation of Copolyamide:

50 g (400 mmol) of the α-amino-ε-caprolactam prepared in step (1) of Example 1 and 450 g (3540 mmol) 2-azonanone were heated and melted in an autoclave, and then 15 mL (830 mmol) water was added. The resultant mixture was subjected to an increased pressure reaction at 190° C. and 0.8 MPa for 6 h, followed by a normal pressure reaction at 220° C. and 0 MPa for 1 h, and then a reduced pressure reaction at 220° C. and −0.1 MPa for 1.5 h. The resultant mixture was discharged and granulated to obtain the copolyamide product with a yield of 81%, and a number average molecular weight of 36.9 kDa as measured by GPC. ¹H-NMR spectroscopy test results: ¹H NMR (500 MHz, TFA/CDCl₃, 1:5, v:v): δ 3.31-3.02 (m, 5H), 2.35-2.19 (m, 2H), 1.78-1.02 (m, 14H).

### (2) Preparation of Antimicrobial Nylon:

500 mL ethanol and 50 g acetic acid were added into 100 g of the copolyamide granules prepared in above step (1). The resultant mixture was heated under reflux at 70° C. for 5 h and then filtered. The granules were put into 1000 mL water and washed with water at 70° C. for 5 h to obtain antimicrobial nylon granules with a yield of 98%. ¹H NMR spectrum showed that the molar percentage of the protonated seven-membered cyclic lysine derivative in the antimicrobial nylon material was 16.3%.

### Example 18

### (1) Preparation of Copolyamide:

50 g (400 mmol) of the α-amino-ε-caprolactam prepared in step (1) of Example 1 and 450 g (3180 mmol) 2-azonanone were heated and melted in an autoclave, and then 15 mL (830 mmol) water was added. The resultant mixture was subjected to an increased pressure reaction at 190° C. and 0.8 MPa for 6 h, followed by a normal pressure reaction at 220° C. and 0 MPa for 1 h, and then a reduced pressure reaction at 220° C. and −0.1 MPa for 1.5 h. The resultant mixture was discharged and granulated to obtain the copolyamide product with a yield of 83%, and a number average molecular weight of 52.3 kDa as measured by GPC. ¹H-NMR spectroscopy test results: ¹H NMR (500 MHz, TFA/CDCl₃, 1:5, v:v): δ 3.27-3.05 (m, 5H), 2.39-2.16 (m, 2H), 1.83-1.15 (m, 16H).

### (2) Preparation of Antimicrobial Nylon:

500 mL ethanol and 50 g acetic acid were added into 100 g of the copolyamide granules prepared in above step (1). The resultant mixture was heated under reflux at 70° C. for 5 h and then filtered. The granules were put into 1000 mL water and washed with water at 70° C. for 5 h to obtain antimicrobial nylon granules with a yield of 99%. ¹H NMR spectrum showed that the molar percentage of the protonated seven-membered cyclic lysine derivative in the antimicrobial nylon material was 17.2%.

### Comparative Example 1

500 g (4400 mmol) caprolactam was heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain a homopolymerized nylon product with a yield of 85%, and a number average molecular weight of 26.3 kDa as measured by GPC. ¹H-NMR spectroscopy test results: ¹H NMR (500 MHz, TFA/CDCl₃, 1:5, v:v): δ 3.25-3.17 (m, 2H), 2.25-2.19 (m, 2H), 1.78-1.16 (m, 6H).

### Comparative Example 2

### (1) Preparation of Copolyamide:

350 g (2450 mmol) of the α-amino-ε-caprolactam prepared in step (1) of Example 1 and 250 g (2200 mmol) ε-caprolactam were heated and melted in an autoclave, and then 18 mL (1000 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 80%. The product is insoluble in hexafluoroisopropanol, so that the GPC could not be measured. ¹H-NMR spectroscopy test results: ¹H NMR (500 MHz, TFA/CDCl₃, 1:5, v:v): δ 3.32-2.90 (m, 5H), 2.37-2.16 (m, 2H), 1.73-1.20 (m, 12H).

### (2) Preparation of Antimicrobial Nylon:

1000 mL ethanol and 500 g acetic acid were added into 100 g of the copolyamide granules prepared in above step (1). The resultant mixture was heated under reflux at 70° C. for 5 h and then filtered. The granules were put into 1000 mL water and washed with water at 70° C. for 5 h with a yield of 98%. The molar percentage of the protonated seven-membered cyclic lysine derivative in the antimicrobial nylon material was 56%.

### Comparative Example 3

### (1) Preparation of Copolyamide:

2.5 g (20 mmol) of the α-amino-ε-caprolactam prepared in step (1) of Example 1 and 497.5 g (4370 mmol) ε-caprolactam were heated and melted in an autoclave, and then 15 mL (830 mmol) water was added. The resultant mixture was subjected to an increased pressure reaction at 190° C. and 0.8 MPa for 6 h, followed by a normal pressure reaction at 210° C. and 0 MPa for 1 h, and then a reduced pressure reaction at 210° C. and −0.1 MPa for 1 h. The resultant mixture was discharged and granulated to obtain the copolyamide product with a yield of 80%, and a number average molecular weight of 17.8 kDa as measured by GPC. ¹H-NMR spectroscopy test results: ¹H NMR (500 MHz, TFA/CDCl₃, 1:5, v:v): δ 3.26-3.08 (m, 5H), 2.30-2.18 (m, 2H), 1.74-1.19 (m, 12H).

### (2) Preparation of Antimicrobial Nylon:

1000 mL methanol and 20 g acetic acid were added into 100 g of the copolyamide granules prepared in above step (1). The resultant mixture was heated under reflux at 70° C. for 5 h and then filtered. The granules were put into 1000 mL water and washed with water at 70° C. for 5 h with a yield of 97%. The molar percentage of the protonated seven-membered cyclic lysine derivative in the antimicrobial nylon material was 0.4%.

### Effect Example

### Antimicrobial Effect Test:

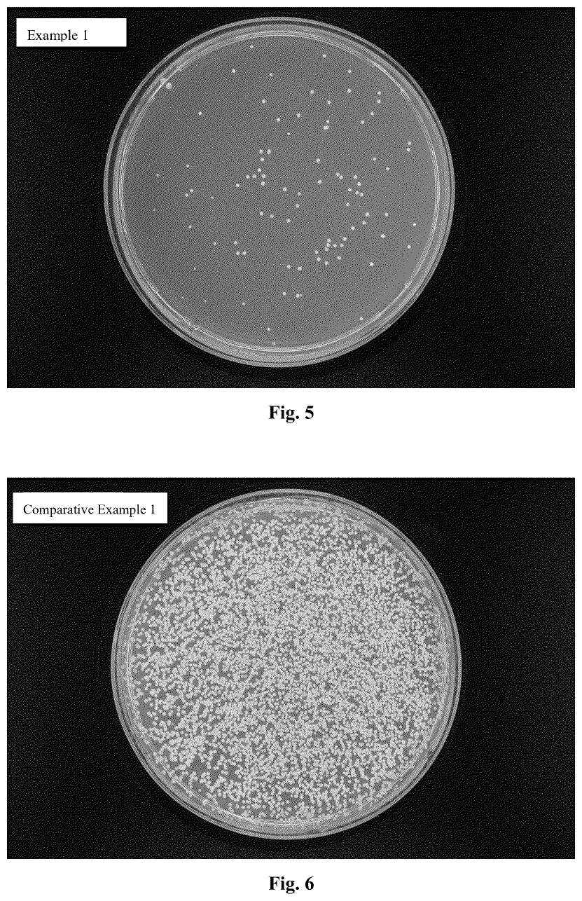

The antimicrobial effect was tested in accordance with the method in the Chinese National Standard GB/T 31402-2023 with modifications for some conditions based on practical situations. Specific operations were as follows: each of the antimicrobial nylon materials prepared in Examples 1-18 and the nylon materials prepared in Comparative Examples 1-3 above were pressed into a 5 cm×5 cm square sheet, sprayed with 75% alcohol and then dried in the air. The sheet was sterilized by irradiation under a UV lamp for 30 min; then 0.4 mL of a bacteria solution was dropped onto the sheet with a concentration of 6×10⁵ CFU/mL, covered with a PET film and then incubated at 37° C. for 24 h. The sheet was rinsed with 10 mL SCDLP liquid medium and the obtained bacteria solution was diluted. After a gradient dilution, the bacteria solution was mixed with a PCA medium, and incubated at 37° C. for 48 h. The colonies in the medium were counted with an automated colony counter, and the bacteria concentration in the bacteria solution after incubation was calculated. The conventional nylon material obtained in Comparative Example 1 was used as a control group. FIG. 5 and FIG. 6 respectively showed comparative photos of the antimicrobial effects of the nylon materials prepared in Example 1 and Comparative Example 1 against Staphylococcus aureus, both of which the dilution ratio was 100. The spots shown in the figures were survival colonies. It could be clearly seen from the figures that, as compared to the conventional nylon material prepared in Comparative Example 1, the antimicrobial nylon materials of the present disclosure have significant inhibitory effect against Staphylococcus aureus. The bacteria used for the test were Staphylococcus aureus (S. Aureus) ATCC6538 and Escherichia coli (E. coli) ATCC25922. The test results were as shown in Table 1.

The antimicrobial ratio is calculated according to the following equation:

$$\frac{\begin{matrix}Bacteria Concentration of Control Group - \\ Bacteria Concentration of Test Sample\end{matrix}}{Bacteria Concentration of Control Group} \times 100 \% = Antimicrobial Ratio$$

### Mechanical Property Test:

Each of the antimicrobial nylon materials prepared in Examples 1-18 and the nylon materials prepared in Comparative Examples 1-3 was injection molded into a 5A-type specimen (with dimensions in accordance with the Chinese National Standard GB/T 1040.2-2022), which was tested for tensile property. The results were shown in Table 1.

As seen from the data in Table 1, the antimicrobial nylon materials of the present disclosure have significantly improved antimicrobial effects and substantially comparable mechanical properties as compared to the conventional nylon material (Comparative Example 1). In contrast, the nylon material of Comparative Example 2 has worse mechanical properties, and the nylon material of Comparative Example 3 has insufficient antimicrobial effects.

TABLE 1

| | Antimicrobial Efficiency | | | |
|---|---|---|---|---|
| | Antimicrobial | Antimicrobial | Tensile Property | |
| | ratio against | ratio against | Tensile | Elongation |
| | Staphylococcus | Escherichia | strength | at break |
| Example Number | aureus (%) | coli (%) | (MPa) | (%) |
| Example 1 | 96.5 | 97.8 | 76 | 20 |
| Example 2 | 92.3 | 93.1 | 78 | 16 |
| Example 3 | 96.7 | 99.2 | 72 | 14 |
| Example 4 | 97.0 | 98.3 | 68 | 14 |
| Example 5 | 97.5 | 99.0 | 65 | 15 |
| Example 6 | 99.0 | 99.5 | 60 | 12 |
| Example 7 | 78.5 | 80.7 | 77 | 20 |
| Example 8 | 92.3 | 93.4 | 76 | 19 |
| Example 9 | 90.5 | 92.1 | 73 | 18 |
| Example 10 | 89.5 | 88.1 | 74 | 18 |
| Example 11 | 87.5 | 98.2 | 72 | 16 |
| Example 12 | 94.4 | 90.5 | 77 | 19 |
| Example 13 | 96.0 | 92.4 | 76 | 20 |
| Example 14 | 99.5 | 96.8 | 75 | 21 |
| Example 15 | 82.4 | 83.0 | 70 | 15 |
| Example 16 | 95.7 | 98.0 | 58 | 11 |
| Example 17 | 96.9 | 97.5 | 65 | 13 |
| Example 18 | 94.3 | 96.2 | 70 | 17 |
| Comparative | 0 | 0 | 79 | 20 |
| Example 1 | | | | |
| Comparative | 92.4 | 95.5 | 22 | 5 |
| Example 2 | | | | |
| Comparative | 17.5 | 8.6 | 78 | 19 |
| Example 3 | | | | |

The preferred embodiments of the present disclosure are described in detail above. However, the present disclosure is not limited to the specific details of the above embodiments. Various simple variations can be made to the technical solutions of the present disclosure within the technical concept of the present disclosure, and all these simple variations fall within the protection scope of the present disclosure.

Further, it should be noted that various specific technical features described in the above specific embodiments can be combined in any suitable manner without contradiction. To avoid unnecessary repetition, various possible combinations are not further described in the present disclosure.

In addition, various embodiments of the present disclosure can also be combined in any manner, if they do not depart from the spirit of the present disclosure, and the combinations should also be regarded as being within the present disclosure.

1. An antimicrobial nylon material comprising two different kinds of repeating units respectively represented by following Formula I and Formula II in its molecular structure: 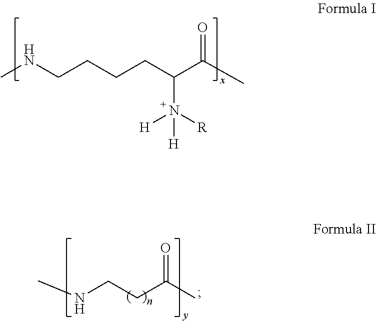
wherein R is one selected from the group consisting of hydrogen; substituted or unsubstituted, linear or branched, saturated or unsaturated aliphatic C₁₋₂₈ hydrocarbyl; substituted or unsubstituted, saturated or unsaturated alicyclic C₃₋₁₅ hydrocarbyl; substituted or unsubstituted C₆₋₂₂ aryl; and substituted or unsubstituted, saturated or unsaturated C₇₋₃₅ aralkyl; wherein the expression “substituted” means that the respective group is substituted by one or more substituents selected from halogen, nitro, and linear or branched C₁₋₁₈ alkyl;
n is any natural number selected from 1 to 8; and
x and y represent the molar ratio of respective repeating units, wherein x is selected from 0.01 to 0.50, y is selected from 0.50 to 0.99, and x+y=1.

2. A method for preparing the antimicrobial nylon material of claim 1, comprising the steps of:
Step 1: mixing a seven-membered cyclic lysine-derived monomer with a lactam to occur a hydrolysis polymerization with water as an initiator to obtain a copolyamide; and
Step 2: placing the copolyamide into an acid solution, heating and stirring the solution to occur a protonation reaction, and then purifying the resultant reaction product to obtain the antimicrobial nylon material,
wherein the seven-membered cyclic lysine-derived monomer has a structure represented by Formula III, or is a salt form cyclic lysine monomer obtained by reacting the pendant amino on the ring of the structure represented by Formula III with an acid: 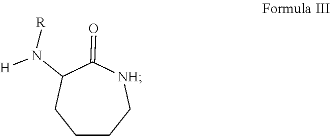
the lactam has a structure represented by Formula IV:

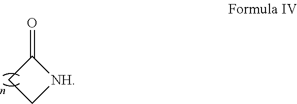

3. The method for preparing the antimicrobial nylon material according to claim 2, wherein the seven-membered cyclic lysine-derived monomer is obtained through a method comprising steps of:
mixing lysine or lysine hydrochloride with methanol, with or without adding an equimolar equivalent of sodium hydroxide, to occur a dehydration-cyclization reaction at 125° C.-200° C., and then extracting a reaction mixture with ethyl acetate; or
reacting an α-amino-ε-caprolactam with a corresponding acid, aldehyde or halohydrocarbon having an R group; or
reacting an unprotected or mono-protected cyclic lysine monomer with an acid.

4. The method for preparing the antimicrobial nylon material according to claim 2, wherein in above step 1, the molar ratio of the seven-membered cyclic lysine-derived monomer to the lactam is in a range from 0.01:1 to 1:1; and
the ratio of the total mass of the 7-membered cyclic lysine-derived monomer and the lactam to the mass of water is in a range from 10:1 to 200:1.

5. The method for preparing the antimicrobial nylon material according to claim 2, wherein a catalyst is added in above step 1, the catalyst is one or a mixture of at least two selected from the group consisting of hydrides or oxyacids of halogen; oxyacids of sulfur, nitrogen or phosphorous; C₁₋₃₅ mono- to penta-carboxylic acids, hydroxy acids, amino acids, sulfonic acids or phosphoric acid; hydroxides, carbonates, bicarbonates or basic carbonates of alkaline metal or alkaline earth metal; and
the molar ratio of the catalyst to the sum of the 7-membered cyclic lysine-derived monomer and the lactam is in a range from 0.001:1 to 0.1:1.

6. The method for preparing the antimicrobial nylon material according to claim 2, wherein the hydrolysis polymerization in above step 1 is occurred under the following conditions: a polymerization temperature of 140° C.-320° C., a polymerization time of 2 h-96 h, and a polymerization pressure of −0.1 MPa-5 MPa.

7. The method for preparing the antimicrobial nylon material according to claim 2, wherein the hydrolysis polymerization in above step 1 is divided into three stages of increased pressure reaction, normal pressure reaction, and reduced pressure reaction, which are occurred under the following reaction conditions respectively:
Stage of increased pressure reaction: a polymerization temperature of 140° C.-230° C., a polymerization time of 2 h-24 h, and a polymerization pressure of 0.3 MPa-5 MPa;
Stage of normal pressure reaction: a polymerization temperature of 180° C.-280° C., a polymerization time of 0.5 h-10 h, and a polymerization pressure of −0.05 MPa-0.1 MPa;
Stage of reduced pressure reaction: a polymerization temperature of 200° C.-320° C., a polymerization time of 2 h-36 h, and a polymerization pressure of −0.1 MPa-0 MPa.

8. The method for preparing the antimicrobial nylon material according to claim 2, wherein an acid used in the acid solution in above step 2 is one or a mixture of at least two selected from the group consisting of hydrides or oxyacids of halogen; hydrides or oxyacids of sulfur, nitrogen or phosphorous; C₁₋₃₅ mono- to penta-carboxylic acids, hydroxy carboxylic acids or sulfonic acids; and
a solvent used in the acid solution is one or a mixture of at least two selected from the group consisting of diethyl ether, methyl t-butyl ether, tetrahydrofuran, ethylene carbonate, propylene carbonate, acetonitrile, methyl ethyl ketone, acetone, methanol, ethanol, butanol, dichloromethane, carbon disulfide, chloroform, ethyl acetate, ethyl isovalerate, N,N-dimethylformamide, N,N-dimethylacetamide, and dimethyl sulfoxide.

9. The method for preparing the antimicrobial nylon material according to claim 2, wherein in above step 2, for protonating each gram of copolyamide, 0.1 mL-20 mL of a solvent and 0.01 g-10 g of an acid is required for the acid solution; the temperature for heating is 20° C.-180° C.; and the time for stirring is 10 min-48 h.

10. An antimicrobial nylon article comprising the antimicrobial nylon material of claim 1, wherein the antimicrobial nylon article is selected from textiles, plates, pipes, packages or panels.
